(19) United States
(12) Patent Application Publication
(10) Pub. No.: US 2015/0364963 A1
(43) Pub. Date: Dec. 17, 2015

(54) VERTICAL POWER TOOL

(71) Applicant: RYOBI LTD., Fuchu-shi, Hiroshima (JP)

(72) Inventor: Yasuhiro TANABE, Hiroshima (JP)

(21) Appl. No.: 14/765,517

(22) PCT Filed: Jan. 23, 2014
(86) PCT No.: PCT/JP2014/051411

§ 371 Date: Aug. 3, 2015

(30) Foreign Application Priority Data
Feb. 8, 2013 (JP) 2013-023856

(51) Int. Cl. H02K 5/04; H02K 7/14; H02K 5/14; B25F 5/02; H02K 11/00

(52) U.S. Cl. CPC H02K 5/04; B25F 5/02; H02K 11/0068; H02K 5/145; H02K 7/14

(57) ABSTRACT

Provided is a vertical power tool capable of suppressing the overall height of the tool. The vertical power tool has housings 2, 3 to accommodate a motor 1 having a vertically extending axis. A stator 1a of the motor 1 is screwed to an upper portion of the housing 3 from below, a brush holder 9 being laterally inserted into the upper portion the housing 3. A pressing screw 11 is screwed into the housing 3 from below to press an outer peripheral surface of the brush holder 9 by a distal end portion of the pressing screw 11 so that the brush holders 9 is fixed to the housing 3 in a pressed manner. The position at which the stator 1a of the motor 1 is screwed is shifted by a predetermined angle around the axis of the motor 1 with respect to the pressing screw 11.

### TECHNICAL FIELD

The present invention relates to a vertical power tool in which an axis of a motor extends in a vertical direction.

### BACKGROUND ART

As such a vertical power tool, the applicant has already proposed an electric trimmer as disclosed in Patent Document 1 identified below. In the electric trimmer, a stator of a motor is screwed to an upper portion of a housing from below. On the other hand, while a brush holder is laterally inserted into the housing, pressing screw for fixing the brush holder to the housing in a pressed manner is positioned above the brush holder. That is, the pressing screw is screwed into the housing from above to press the brush holder downward by a lower end portion, i.e., a distal end portion of the pressing screw so that the brush holder is fixed to the housing.

In this manner, in the background-art configuration, a female thread portion for screwing the stator of the motor is formed below the brush holder while a female thread portion into which a pressing screw is screwed is formed above the brush holder. It is therefore necessary to provide thick portions above and below the brush holder respectively in order to provide the female thread portions. Thus, there is a problem that the vertical size of the housing increases and the overall height of the tool increases accordingly.

### PRIOR ART DOCUMENT

### Patent Document

Patent Document 1: JP10-217203A

### SUMMARY OF INVENTION

### Problem to be Solved by Invention

The present invention has been made in view of the conventional problem described above. An object of the invention is to provide a vertical power tool capable of suppressing the overall height of the tool.

### Means for Solving the Problem

The present invention has been made to solve the problem described above. A vertical power tool according to the invention includes a housing that accommodates a motor having a vertically extending axis. A stator of the motor is screwed to an upper portion of the housing from below, a brush holder being laterally inserted into the upper portion of the housing. A pressing screw is screwed into the housing from below to press an outer peripheral surface of the brush holder by a distal end portion of the pressing screw so that the brush holder is fixed to the housing in a pressed manner.

According to the vertical power tool having with configuration, it is necessary to form a portion of the housing below the brush holder to be thick enough to screw the stator of the motor thereto. However, due to the configuration in which the pressing screw is screwed into the housing from below, a female thread potion into which the pressing screw is screwed can be easily formed using the vertical size of the thick portion of the housing below the brush holder. That is, a female thread portion for screwing the stator of the motor to the housing and the female thread portion for screwing the pressing screw into the housing are provided collectively below the brush holder so that the thickness of the housing above the brush holder can be reduced.

Particularly it is preferable that a top surface of the housing above the brush holder is at a lower position than a top surface of an edge cover portion of the housing covering an upper end portion of a motor shaft, and that a circuit board configured to control the motor is located between a height of the top surface of the edge cover portion and a height of the top surface of the housing above the brush holder. In a configuration in which a circuit board is provided for controlling the motor, the arrangement of the circuit board is important and gives great influence to the overall height of the tool. Due to the configuration in which the female thread portion for the pressing screw is provided below the brush holder as described above, it is easy to make the upper surface of the housing above the brush holder lower than the upper surface of the edge cover portion of the housing covering the upper end portion of the motor shaft. When the circuit board is disposed in a vertical position between the both, it is possible to suppress the overall height of the tool in spite of the configuration including the circuit board.

It is preferable that a position at which the stator of the motor is screwed is shifted by a predetermined angle around the axis of the motor with respect to the pressing screw, so that the female thread portion for screwing the stator of the motor and the female thread portion for screwing the pressing screw can be easily provided while being prevented from interfering with each other.

It is also a preferable that the upper surface of the housing above the brush holder is configured as a flat surface in order to reduce the thickness of the housing above the brush holder. With this configuration, the circuit board can be disposed in a further lower position, so that the overall height of the tool can be further suppressed.

### Advantage of the Invention

As described above, according to the vertical power tool of the invention, both the female thread portion for screwing the stator of the motor to the housing and the female thread portion for screwing the pressing screw into the housing are provided below the brush holder, so that the thickness of the housing above the brush holder can be reduced, and the overall height of the tool can be suppressed in comparison with a configuration in which female thread portions are separated vertically as in the background art.

### BRIEF DESCRIPTION OF THE DRAWINGS

FIG. 1 is a perspective view showing an electric trimmer that is a vertical power tool according to an embodiment of the invention;

FIG. 2 is a front view of the electric trimmer;

FIG. 3 is a sectional view of relevant portions taken along the line AE-AE in FIG. 2;

FIG. 4 is a sectional view of relevant portions taken along the line AF-AF in FIG. 3;

FIG. 5 is a sectional view of relevant portions taken along the line AH-AH in FIG. 4;

FIG. 6 is a plan view showing a state in which a top cover of the electric trimmer has been removed;

FIG. 7 is a sectional view taken along the line P-P in FIG. 2;

FIG. 8 is a sectional view taken along the line Q-Q in FIG. 2;

FIG. 9 is a sectional view taken along the line AK-AK in FIG. 8;

FIG. 10 is a perspective view of relevant portions, showing the inside of the top cover of the electric trimmer;

FIG. 11A is a front view of a relevant portion, and FIG. 11B is a side view of the relevant portion, showing a state in which a switch of the electric trimmer is ON;

FIGS. 12A and 12B are sectional views of relevant portions taken along the line AG-AG in FIG. 3, illustrating on/off operation of the switch of the electric trimmer, FIG. 12A showing a state in which the switch is OFF, and FIG. 12B showing a state in which the switch is ON;

FIG. 13 is a perspective view of relevant portions with a partially broken line, showing a state in which the electric trimmer is being assembled;

FIG. 14 is a perspective view of relevant portions, showing a state in which the electric trimmer is being assembled; and

FIG. 15 is a perspective view of relevant portions of the electric trimmer.

### EMBODIMENTS OF INVENTION

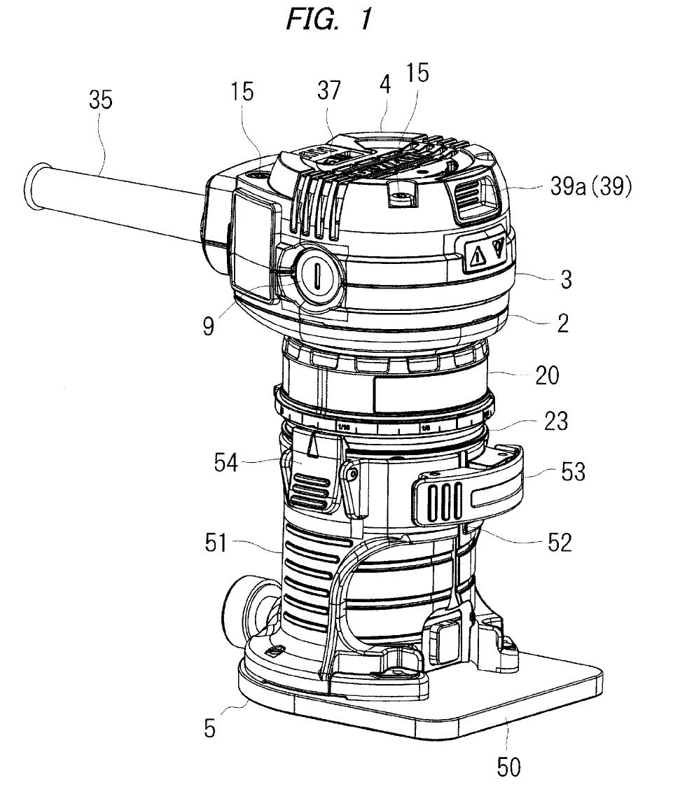

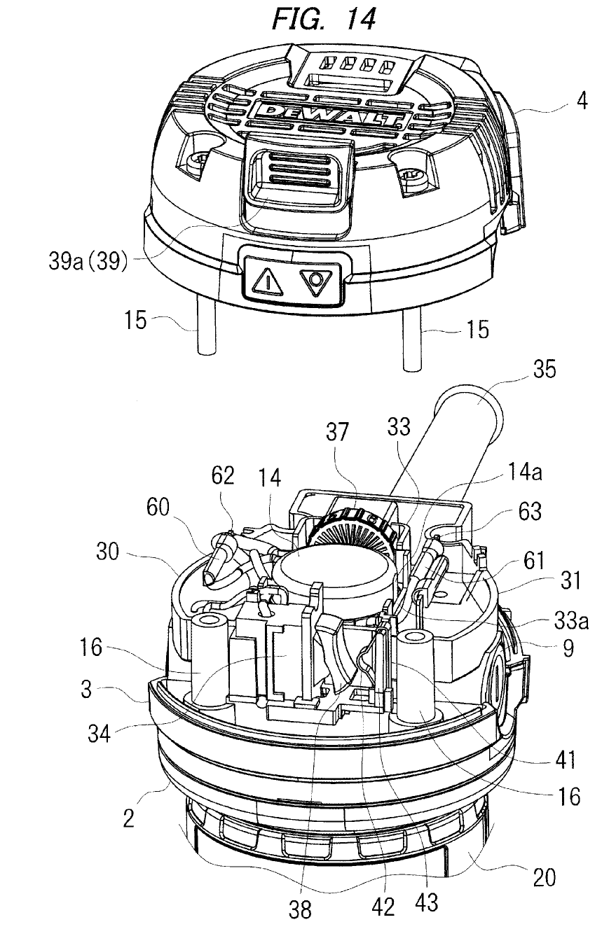

An electric trimmer as a vertical power tool according to an embodiment of the invention will be described below with reference to FIG. 1 to FIG. 15. The electric trimmer according to the embodiment has a motor 1 having a vertically extending axis, a body housing (housing) accommodating the motor 1, a top cover 4 covering an upper portion of the body housing, and a base 5 to which a lower portion of the body housing is inserted so that the body housing can be retained at predetermined height.

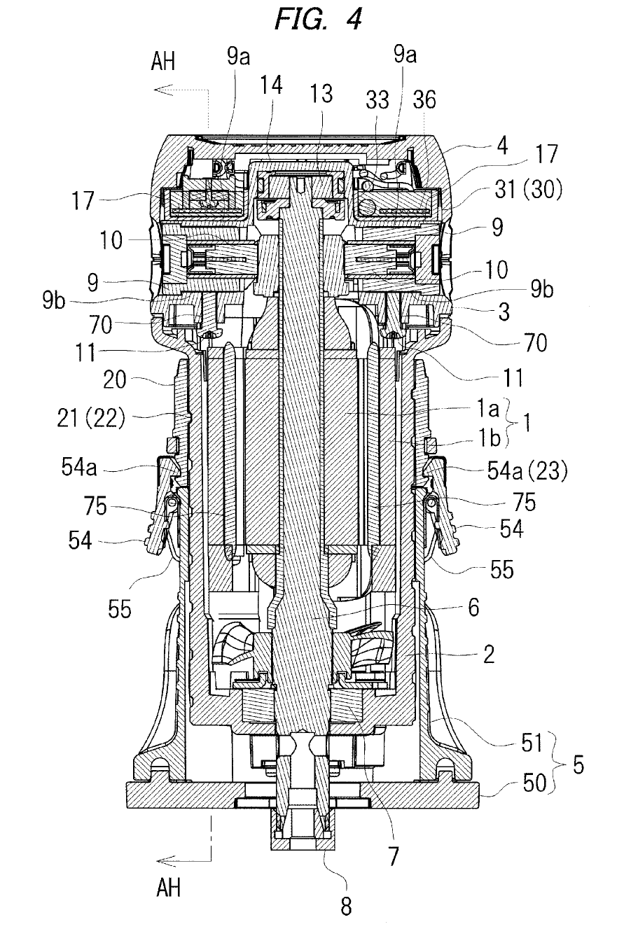

The body housing has a motor case 2 covering a lower side of the motor 1 and a major portion, and a head cover 3 covering an upper portion of the motor 1. The motor case 2 has a cylindrical shape including a bottom and opened in its top as a whole as shown in FIG. 4. In a bottom portion of the motor case 2, a bearing 7 is disposed to support a motor shaft 6. A lower end portion of the motor shaft 6 projects from the motor case 2 so as to extend downward by predetermined length. A chuck 8 is attached to the lower end portion of the motor shaft 6 so that a not-shown bit can be removably attached by the chuck 8. A top opening portion of the motor case 2 is made larger in diameter than a main portion of the motor case 2. The head cover 3 is attached to the upper side of the motor case 2 so as to close the top opening portion of the motor case 2.

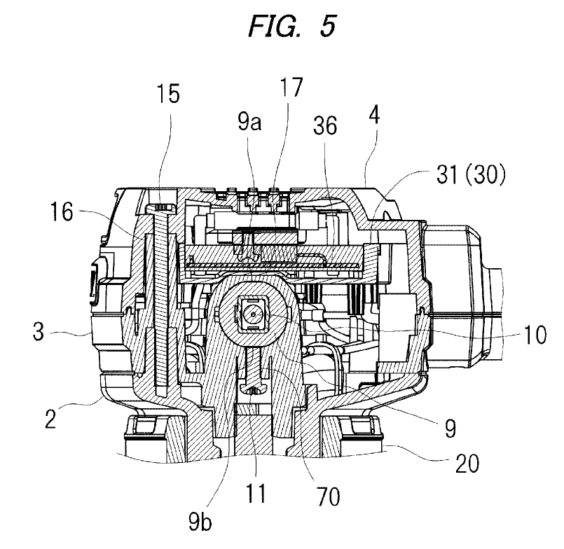

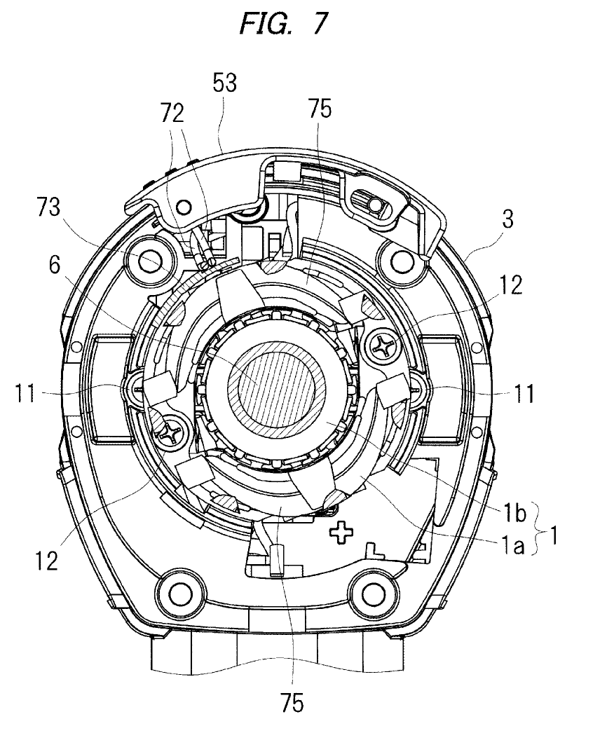

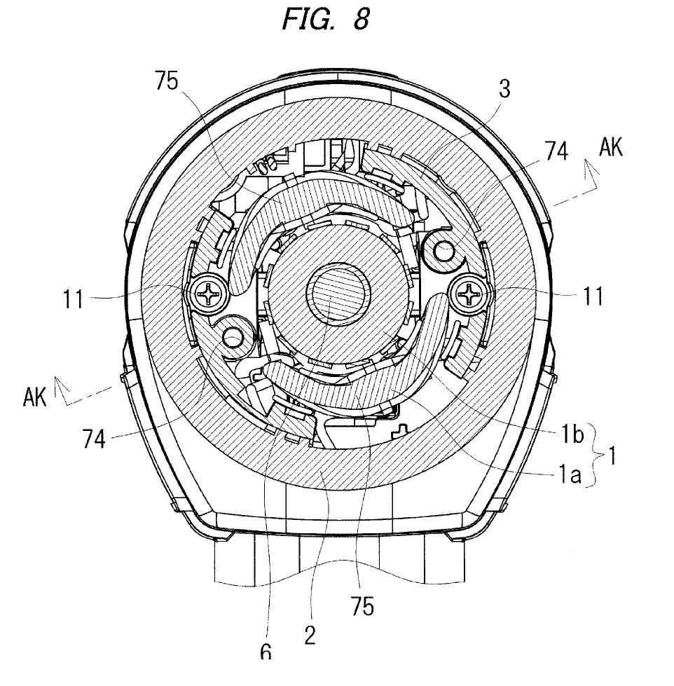

The head cover 3 is also referred to as bracket. A pair of left and right lateral holes opened laterally are formed in the head cover 3, and cylindrical brush holders 9 are inserted into the lateral holes respectively. Brushes 10 are inserted into the brush holders 9. Each brush holder 9 is pressed and fixed to the head cover 3 by a pressing screw 11. The pressing screw 11 is screwed into the head cover 3 from below as also shown in FIG. 5. The outer peripheral surface of the brush holder 9 is pressed upward by a distal end portion of the pressing screw 11 so that the brush holder 9 is fixed to the wall surface of the lateral hole in a pressed manner. Thus, a female thread portion 70 into which the pressing screw 11 is screwed is not formed above the brush holder 9, that is, in an upper portion of the head cover 3, but is formed below the brush holder 9, that is, a lower portion of the head cover 3. As shown in FIG. 5, the pressing screw 11 presses the outer peripheral surface of the brush holder 9 vertically upward toward the center of the brush holder 9. A pair of flat portions 9a, 9b are formed in the outer peripheral surface of the brush holder 9 so as to be opposed to each other at 180 degrees. The brush holder 9 is inserted into the lateral hole of the head cover 3 so that the two flat portions 9a, 9b can face vertically. The pressing screw 11 presses upward the central portion of the flat portion 9b on the lower side of the brush holder 9. That is, the pressing screw 11 is located on a plane passing the axis of the brush holder 9. The pressing screws 11 are provided for the pair of left and right brush holders 9 respectively as also shown in FIGS. 7 and 8. Since the brush holders 9 are disposed to be opposed to each other horizontally at 180 degrees, the pressing screws 11 are also disposed to be opposed to each other horizontally at 180 degrees on one and the same circle around the axis of the motor 1. The motor case 2 and the base 5 are omitted in the illustration of FIG. 7.

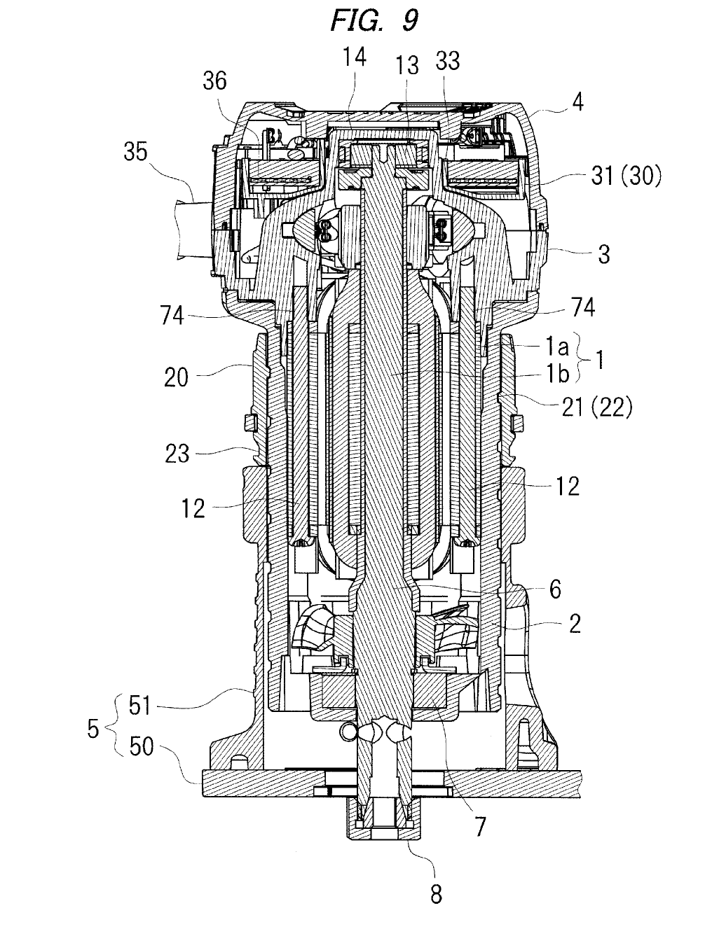

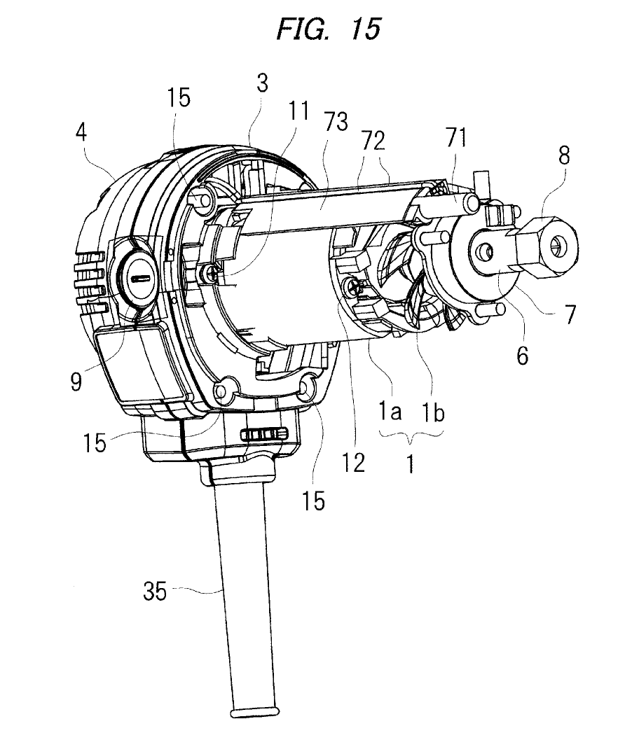

As shown in FIG. 9, the motor 1 is screwed to a lower portion of the head cover 3 from below by motor fixing screws 12. The motor 1 has a configuration in which a stator 1a is provided on the outer side and a rotor 1b having a motor shaft 6 is provided inside the stator 1a. The stator 1a is screwed to the head cover 3 by the motor fixing screws 12. FIG. 15 is a view in which the motor case 2 has been removed so that the lower portion of the motor 1 accommodated in the motor case 2 can be observed easily. The electric trimmer according to the embodiment has a light 71 (specifically an LED light) for illuminating a work area. A wiring cord 72 for supplying electric power to the light 71 extends downward while being guided by a cord guide 73 extending vertically.

As shown in FIG. 7, the motor fixing screws 12 are also provided to be paired and opposed to each other at 180 degrees on one and the same circle around the axis of the motor 1. Accordingly, the pressing screws 11 and the motor fixing screws 12 are placed coaxially, but the motor fixing screws 12 are located inside the pressing screws 11. In addition, the motor fixing screws 12 are disposed to be shifted in phase at predetermined angles circumferentially, that is, around the axis of the motor 1 with respect to the pressing screws 11. Due to the layout with the shifted phase, interference between the motor fixing screws 12 and the pressing screws 11 can be prevented. In addition, due to the configuration in which both the motor fixing screws 12 and the pressing screws 11 are screwed into the lower portion of the head cover 3, female thread portions 74 into which the motor fixing screws 12 are screwed and female thread portions 70 into which the pressing screws 11 are screwed are formed in the lower portion of the head cover 3, but interference between those female thread portions 70 and 74 can be also prevented. Further, since the motor fixing screws 12 are disposed to be shifted at predetermined angles circumferentially around the axis of the motor 1 with respect to the pressing screws 11, that is, the brushes 10, field coils 75 located between the two motor fixing screws 12 respectively are also shifted in phase with respect to the brushes 10 as shown in FIG. 7 and FIG. 8.

A top center portion of the head cover 3 is formed into a shape bulging upward, and the bulging part has a cylindrical shape closed in its upper end and opened in its lower end. A bearing 13 for supporting the upper end portion of the motor shaft 6 is built in the bulging part. The bulging part serves as an edge cover portion 14 covering the upper end portion of the motor shaft 6 from above. In this manner, the motor shaft 6 is supported at two upper and lower locations by the bearing 7 in the bottom portion of the motor case 2 and the bearing 13 in the edge cover portion 14 of the head cover 3.

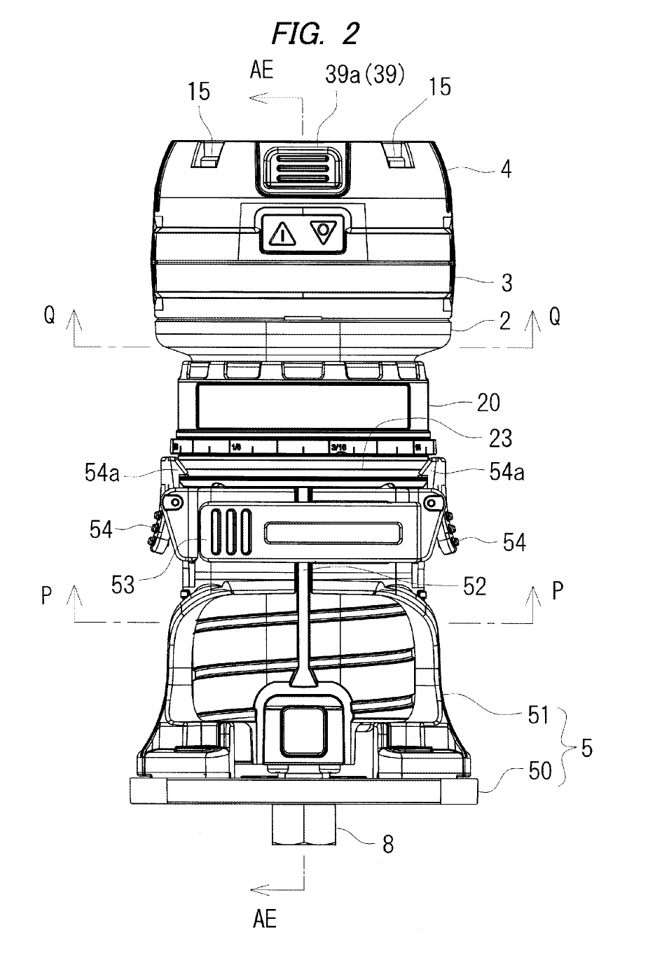

A lower portion of the motor case 2 is inserted into the base 5 from above. The base 5 has a plate-like portion 50 and a cylindrical portion 51 having an opening in its top and attached to the upper surface of the plate-like portion 50 so as to be integrated therewith. The cylindrical portion 51 has a cylindrical shape around the motor shaft 6 in the same manner as the motor case 2. The outer peripheral surface of the cylindrical portion 51 serves as a grip portion to be gripped during work. As shown in FIG. 1 and FIG. 2, a slit 52 extending vertically is formed in the cylindrical portion 51 so that the cylindrical portion 51 can be expanded or contracted slightly by the slit 52. A lever 53 turning horizontally is provided in the upper portion outer peripheral surface of the cylindrical portion 51. When the lever 53 is closed to approach the outer peripheral surface of the cylindrical portion 51, the cylindrical portion 51 is contracted to reduce its diameter. On the contrary, when the lever 53 is opened to leave the outer peripheral surface of the cylindrical portion 51, the cylindrical portion 51 is loosened to expand its diameter. In addition, a pair of left and right hooks 54 are attached to the upper portion outer peripheral surface of the cylindrical portion 51 rotatably around the horizontal axis thereof Each hook 54 is urged by a spring 55 so that an upper portion of the hook 54 can turn radially inward and a lower portion of the hook 54 can turn radially outward. A hook portion 54a is formed inside the upper portion of the hook 54.

On the other hand, a cylindrical operation ring 20 is externally attached to the outer peripheral surface of the main portion of the motor case 2 as shown in FIG. 4. The motor case 2 is inserted into the cylindrical portion 51 of the base 5 from above. A lower end surface of the operation ring 20 abuts against an upper end surface of the cylindrical portion 51 of the base 5 so that the insertion height of the motor case 2 can be determined. In addition, the lower end surface of the operation ring 20 abuts against the upper end surface of the cylindrical portion 51 so that the weight of the motor 1 can be supported by the base 5. Female thread portions 21 are formed in the outer peripheral surface of the main portion of the motor case 2, and male screw portions 22 on the inner peripheral surface of the operation ring 20 are screwed onto the female thread portions 21. An annular groove 23 is formed in the lower portion outer peripheral surface of the operation ring 20, and the hook portions 54a of the pair of left and right hooks 54 are engaged with the annular groove 23. When the lever 53 is opened to loosen the cylindrical portion 51 and expand its diameter, the operation ring 20 can be rotated relatively to the motor case 2 in the state where the hook portions 54a of the hooks 54 are engaged with the annular groove 23. The operation ring 20 rotates while its lower end surface slides on the upper end surface of the cylindrical portion 51. Due to this rotating operation of the operation ring 20, the motor case 2 moves up/down relatively to the base 5, and the motor shaft 6 also moves up/down relatively to the base 5 accordingly. As a result, it is possible to adjust the processing depth in a material to be processed by the bit fixed to the motor shaft 6 by the chuck 8. In addition, when the hook portions 54a of the hooks 54 are removed from the annular groove 23 of the operation ring 20, the motor case 2 can be pulled upward and removed from the base 5 together with the operation ring 20.

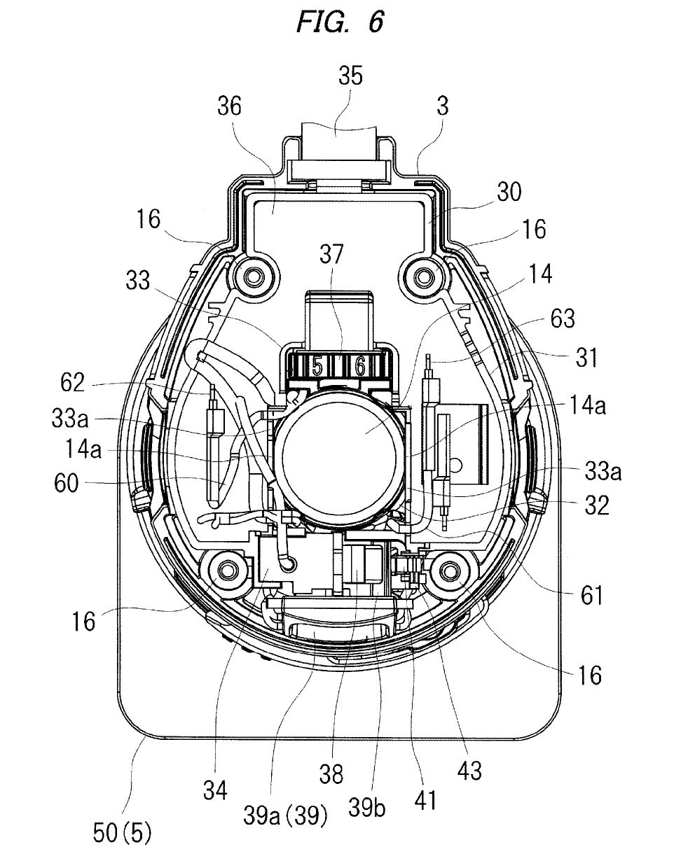

A wiring base 30 is mounted on the upper side of the head cover 3, and a top cover 4 is attached to cover the wiring base 30 from above. The top cover 4 has a cup shape that is opened downward. A lower end circumferential edge portion of the top cover 4 is opposed to a circumferential edge portion of the head cover 3. An accommodating space of a predetermined size is formed in a vertical direction between the top cover 4 and the head cover 3, so that the wiring base 30 is accommodated in the accommodating space. As shown in FIG. 5, the top cover 4 is screwed to the upper portion of the motor case 2 from above by screws 15 together with the head cover 3. In the embodiment, the total number of screws 15 is four as shown in FIG. 6. Thus, a total of four boss portions 16 are provided in the head cover 3 so as to project upward therefrom. The boss portions 16 are located outside the wiring base 30 so as to avoid the wiring base 30.

The wiring base 30 has a shallow bottom case-like shape opened upward as a whole. An outer peripheral wall portion 31 extending upward is provided circumferentially in the circumferential edge portion of the bottom portion of the wiring base 30 excluding a part of the whole circumference. An avoidance hole 32 is formed to vertically extend through the central portion of the wiring base 30 in order to avoid the edge cover portion 14 of the head cover 3. The edge cover portion 14 of the head cover 3 is upwardly inserted to the avoidance hole 32. In this manner, the edge cover portion 14 of the head cover 3 is inserted into the avoidance hole 32 of the wiring base 30 so that the wiring base 30 is located below the top surface of the edge cover portion 14 of the head cover 3 and above a top surface 17 of the head cover 3 above the brush holders 9.

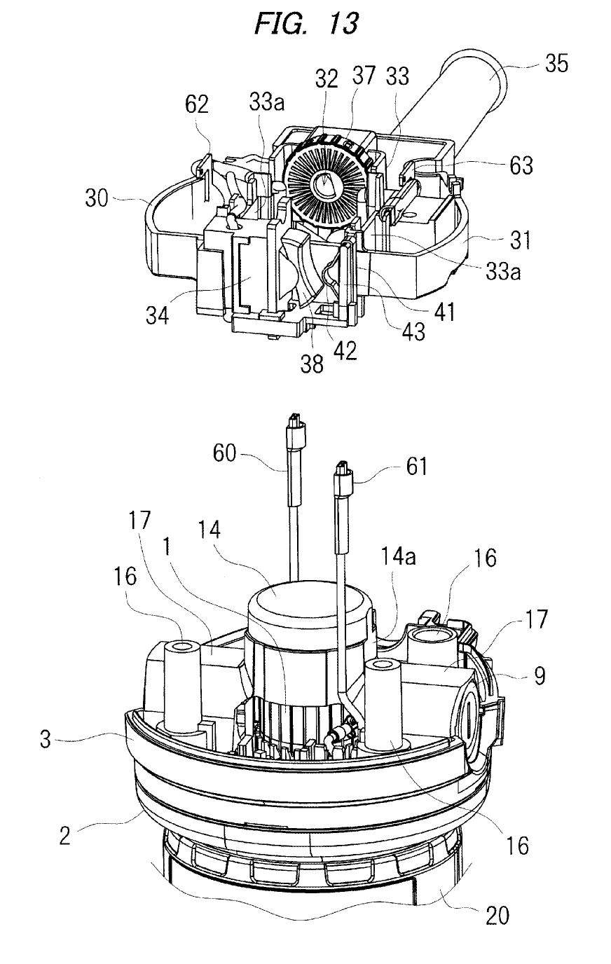

As shown in FIG. 5 and FIG. 13, the top surface 17 of the head cover 3 above each brush holder 9 is configured as a flat surface. The thickness of a portion of the head cover 3 around and above the brush holder 9 is locally made thinner than the other portion. More specifically, the head cover 3 is formed into a shape bulging above the brush holder 9, and the bulging shape is a semi-cylindrical shape extending along the axis of the brush holder 9. However, of the semi-cylindrical bulging shape, a part near the summit portion is formed as a flat surface. Due to the flat surface, this portion is locally thinner than the other portion. In addition, the lower surface of the bottom portion of the wiring base 30 is also recessed upward locally above the brush holder 9 so as to form a concave portion. The upper surface of the bottom portion is also formed locally as a convex shape corresponding to the concave shape in the lower surface of the bottom portion. In addition, the top surface 17 of the head cover 3 above the brush holder 9 enters the concave portion of the bottom portion. In this manner, the top surface 17 of the head cover 3 above the brush holder 9 is formed into a flat surface, while the top surface 17 of the head cover 3 above the brush holder 9 is allowed to upward enter the bottom portion of the wiring base 30. Thus, the height of the wiring base 30 can be further reduced.

An inner peripheral wall portion 33 extending upward is provided circumferentially in the opening edge portion of the avoidance hole 32 of the wiring base 30 so as to surround the circumference of the edge cover portion 14 of the head cover 3. An accommodating portion for accommodating a circuit board 36 is formed between the outer peripheral wall portion 31 and the inner peripheral wall portion 33. As also shown in FIG. 13, of the inner peripheral wall portion 33, parts located on the opposite left and right sides of the edge cover portion 14 of the head cover 3 are formed in parallel with each other and along the front-rear direction. These parts are arranged as positioning guide walls 33a. A pair of left and right flat surface portions 14a are formed to be flat partially in the outer peripheral surface of the edge cover portion 14 of the head cover 3. The pair of left and right flat surface portions 14a are opposed to the pair of left and right guide walls 33a respectively so that the wiring base 30 can be positioned with respect to the edge cover portion 14 of the head cover 3.

A switch 34 for activating and deactivating the motor 1, a power cord 35, the circuit board 36, and a speed dial 37 for adjusting the speed of the motor 1 are attached to the wiring base 30. The switch 34 is attached to a front end portion of a circumferential edge portion of the wiring base 30, which is a place where the outer peripheral wall portion 31 is not formed partially. The switch 34 is of a type called a local switch or a seesaw switch, which is provided with a switching portion 38 turning like a seesaw. In the embodiment, the switch 34 is disposed laterally. Accordingly, the switching portion 38 turns vertically around the horizontal axis of the switch 34. When the switching portion 38 turns downward, the switch 34 is turned off. On the contrary, when the switching portion 38 turns upward, the switch 34 is turned on.

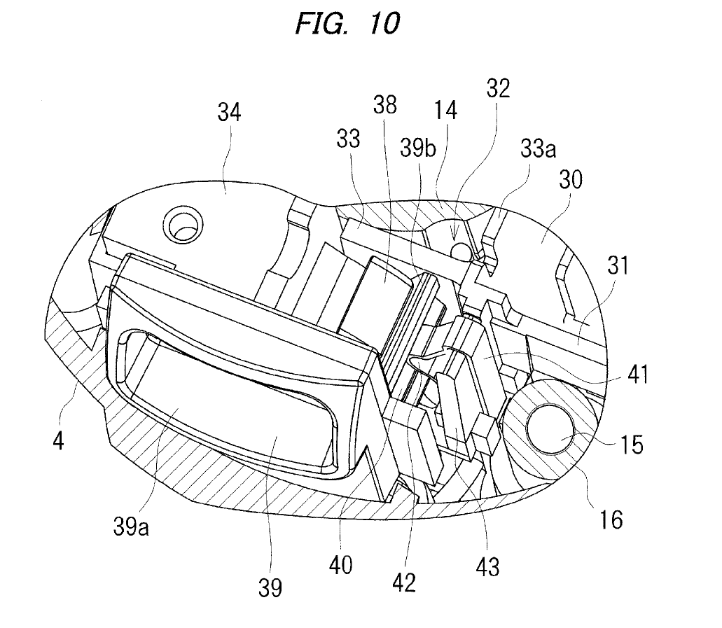

Since the switch 34 is covered by the top cover 4, the switching portion 38 cannot be operated directly from the outside. Therefore, a switch operation member 39 is provided to switch the switch 34 on and off. The switch operation member 39 is provided in the top cover 4 so that a part of the switch operation member 39 can be exposed over the surface of the top cover 4 as an operation portion 39a. An arm portion 39b projects inward from the inner surface of the operation portion 39a. One side face of the arm portion 39b is opposed to a to-be-pressed surface of the switching portion 38 of the switch 34 so as to serve as a pressing face, which has a function of turning the switching portion 38. To facilitate understanding, FIG. 6 and FIG. 10 show the switch operation member 39 which has not been attached to the top cover 4 but has been intentionally located on the wiring base 30 side. As shown in FIG. 6, in planar view, the switch 34 is located inside the switch operation member 39 and between the switch operation member 39 and the edge cover portion 14 of the head cover 3.

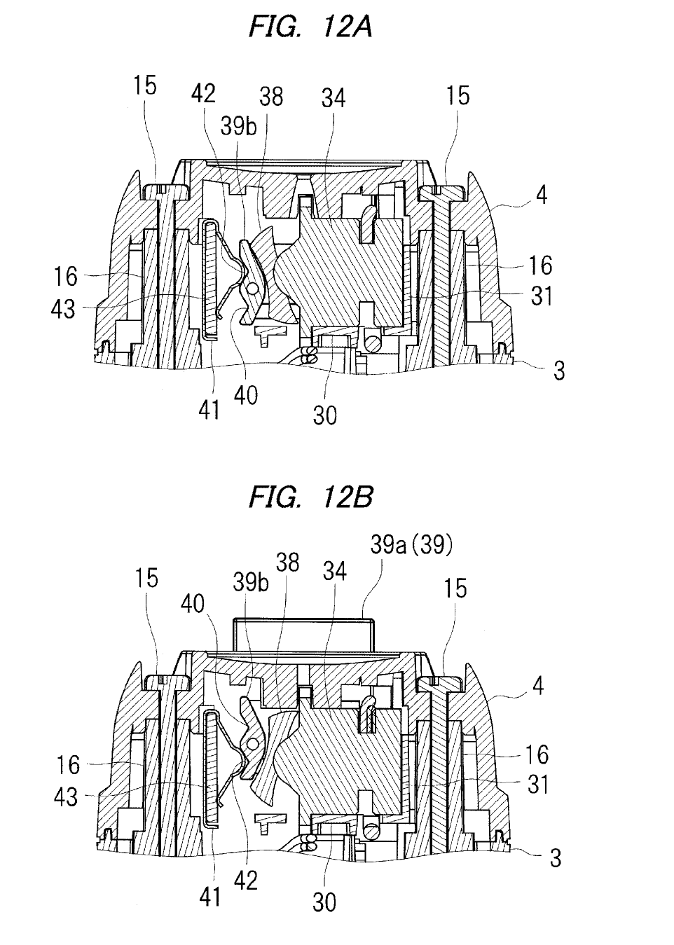

As shown in FIGS. 12, one side surface of the arm portion 39b is a curved surface convex toward the switching portion 38 of the switch 34. On the other hand, the to-be-pressed surface of the switching portion 38 of the switch 34 opposed to the side surface of the arm portion 39b is a concave curved surface. In addition, a pair of upper and lower concave portions 40 are formed in the other side surface of the arm portion 39b. A convex portion of a plate spring 41 for pressing and urging the arm portion 39b toward the switching portion 38 of the switch 34 is engaged with one of the concave portions 40. That is, a spring mounting wall 43 is provided to protrude on a side of the switching portion 38 of the switch 34 and at a predetermined distance from the switching portion 38. The spring mounting wall 43 is composed of a part of the outer peripheral wall portion 31 of the wiring base 30. Specifically the spring mounting wall 43 is formed in a circumferential end portion of the outer peripheral wall portion 31. The plate spring 41 has a two-fold shape folded back at an upper portion thereof. The plate spring 41 is inserted into the spring mounting wall 43 from above. That is, one plate portion of the plate spring 41 is located on the switching portion 38 side of the switch 34, and the other plate portion of the plate spring 41 is located on the opposite side to the switching portion 38 of the switch 34. The one plate portion of the plate spring 41 is formed into air L shape as a whole, and a bent portion 42 thereof is formed as a convex portion, which is engaged with one of the concave portions 40 of the switch operation member 39. The other plate portion of the plate spring 41 extends downward along the spring mounting wall 43, and a lower end portion thereof is bent substantially at right angles and located under the lower surface of the spring mounting wall 43. In this manner, the lower end portion of the other plate portion of the plate spring 41 is located under the lower surface of the spring mounting wall 43 and serves as a lock portion, so that the plate spring 41 can be prevented from leaving the spring mounting wall 43 from above. The movement of the plate spring 41 beyond a predetermined distance is also suppressed by the outer peripheral surface of the boss portion 16 of the head cover 3 and the inner surface of the top cover 4.

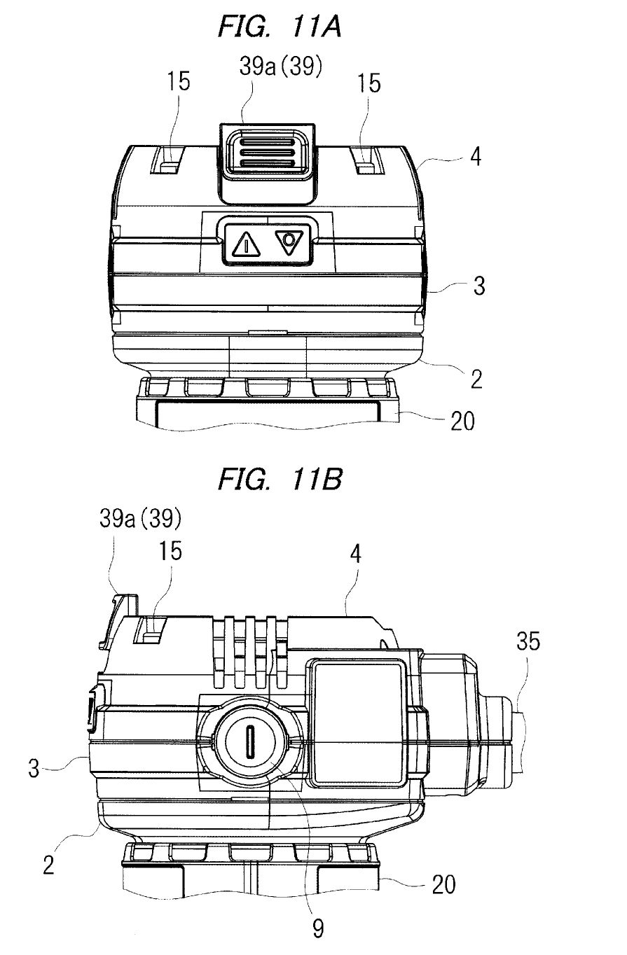

The switch operation member 39 has a configuration capable of reciprocating vertically. When the switch operation member 39 is slid and moved downward, the switch 34 is turned off. When the switch operation member 39 is slid and moved upward, the switch 34 is turned on. When the switch 34 is OFF, the switch operation member 39 does not project upward from the top cover 4 as shown in FIG. 1 to FIG. 3. When the switch operation member 39 is pulled up to project upward from the top cover 4 as shown in FIGS. 11, the switch 34 is turned on. Assume that the inside of the top cover 4 is in the state shown in FIG. 12. When the switch operation member 39 is pushed down to turn off the switch 34, the arm portion 39b of the switch operation member 39 also located in a lower position pushes down and turns the switching portion 38 of the switch 34 as shown in FIG. 12A. In this state, the bent portion 42 of the plate spring 41 is in engagement with the upper concave portion 40 of the arm portion 39b of the switch operation member 39. When the switch operation member 39 is pulled upward to turn on the switch 34, the arm portion 39b of the switch operation member 39 also located in an upper position pushes up and turns the switching portion 38 of the switch 34 as shown in FIG. 12B. In this state, the bent portion 42 of the plate spring 41 is in engagement with the lower concave portion 40 of the arm portion 39b of the switch operation member 39. In this manner, the concave portions 40 are formed in the arm portion 39b of the switch operation member 39, and the bent portion 42 of the plate spring 41 is engaged with one of the concave portions 40 so that click feeling can be obtained and the switch operation member 39 can be retained surely in the upper ON position or the lower OFF position. In addition, the switch operation member 39 projects upward from the top cover 4 when the switch 34 is ON. Accordingly, due to the good visibility, the motor 1 can be stopped quickly and easily only if the switch operation member 39 is pushed down even when emergency stop of the motor 1 is required during work. In addition, since the operation portion 39a of the switch operation member 39 does not project forward from the top cover 4 or the head cover 3, there is no fear that the operation portion 39a may interfere with a visual range when a work area is observed from above. In addition, if the switch 34 is placed vertically with the switching portion 38 on the upper side, the vertical installation space will increase or project laterally due to wiring terminals. However, when the switch 34 is placed laterally with the switching portion 38 in a lateral position, it is not necessary to provide a projecting portion but it is possible to secure good visibility and it is also possible to make the vertical size compact.

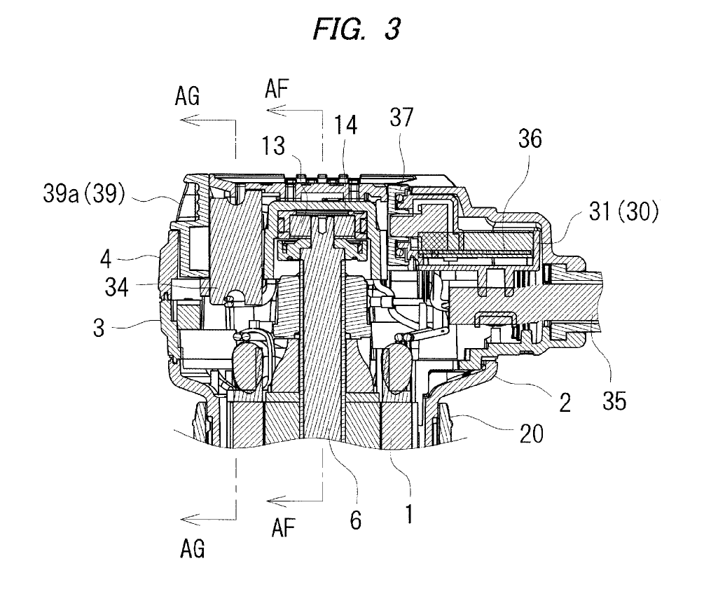

The power cord 35 is attached to the rear portion lower surface of the wiring base 30 and extends rearward and substantially horizontally. In addition, the circuit board 36 is provided for controlling the motor I and particularly for feedback control in the embodiment. The circuit board 36 is attached to the upper side of the wiring base 30, particularly the upper surface of the bottom portion or slightly at an upward distance from the upper surface. The circuit board 36 is disposed inside the outer peripheral wall portion 31 of the wiring base 30. In addition, the edge cover portion 14 of the head cover 3 is upwardly inserted into the avoidance hole 32 of the wiring base 30, and the circuit board 36 is formed into a shape capable of avoiding the edge cover portion 14 of the head cover 3. As shown in FIGS. 3, 9 and 10, the circuit board 36 is located below the top surface of the edge cover portion 14 of the head cover 3. Specifically, the circuit board 36 is branched into the left and right to avoid the edge cover portion 14 of the head cover 3 from the rear portion to the front side. When the circuit board 36 is thus formed into a Y shape as a whole in planar view, that is, a two-branched shape, it is possible to secure the area of the circuit board 36 while preventing interference with the edge cover portion 14 of the head cover 3. The circuit board 36 is resin molded by synthetic resin such as epoxy resin. When the motor 1 is not controlled, it is sufficient that the circuit board 36 has a small area. For example, in a configuration in which the motor 1 is not controlled but the light 71 for illuminating a work area is provided as described above, the circuit board 36 may have a small area because it is sufficient if the circuit board 36 is provided for the light 71.

The speed dial 37 is attached to the wiring base 30 so as to be located behind the edge cover portion 14 of the head cover 3 as shown in FIG. 6. The speed dial 37 is located in the avoidance hole 32 and rotates around a horizontal axis extending in the front-back direction. As shown in FIG. 1, only an upper portion of the speed dial 37 is exposed over the top surface of the top cover 4 so that the speed dial 37 can be rotationally operated by the exposed upper portion.

The switch 34, the circuit board 36, the power cord 35 and the speed dial 37 are thus attached to the wiring base 30 as described above. Wiring among them is achieved in the wiring base 30. That is, wiring among the switch 34, the circuit board 36, the power cord 35 and the speed dial 37 is completed in the wiring base 30. Wiring with the motor 1 is performed as follows. That is, two wiring cords 60, 61 shown in FIG. 6 are connected to the motor 1. The wiring cords 60, 61 extends upward through the avoidance hole 32. End portions of the wiring cords 60, 61 are plugged into and electrically connected to connectors 62, 63 provided to project over the top surface of the circuit board 36, respectively. Electric wiring between the motor 1 and the circuit board 36 is achieved by the two wiring cords 60, 61. In the embodiment, the light 71 (see FIG. 15) for illuminating a work area is provided in a lower portion of the motor case 2. Therefore, a wiring cord 72 is also required for supplying electric power to the light 71. An upper end of the wiring cord 72 is connected to the circuit board 36. The wiring cord 72 is guided by a cord guide 73 and extends to the lower portion of the motor case 2.

Next, an outline of steps of assembling the electric trimmer having the configuration described above will be described. First, the stator 1a of the motor 1 is screwed to the lower portion of the head cover 3 by the motor fixing screws 12, and the brush holders 9 inserted into the lateral holes of the head cover 3 are pressed and fixed by the pressing screws 11. Both the motor fixing screws 12 and the pressing screws 11 are screwed into the head cover 3 from below. Therefore, screwing work can be performed from the same direction. In advance, the rotor 1b of the motor 1 is set inside the motor case 2 in the state where the motor shaft 6 is pressed into the bearing 7. Then the rotor 1b of the motor 1 set in the motor case 2 is inserted into the stator 1 a of the motor 1 screwed to the head cover 3, so as to combine the head cover 3 and the motor case 2 with each other.

After the body housing is assembled, the wiring base 30 is mounted thereon as shown in FIG. 13. Electric components such as the switch 34, the speed dial 37, the power cord 35 and the circuit board 36 have been already attached to the wiring base 30 and wiring has been performed. Those are set on the body housing as a unit. Of the total of four wiring cords 60, 61 from the motor 1, two have been connected to a pair of brushes 10 respectively. The other two wiring cords 60, 61 are extracted upward as shown in FIG. 13. The wiring cords 60, 61 extracted upward through the avoidance hole 32 of the wiring base 30 are connected to the connectors 62, 63 of the circuit board 36 respectively as shown in FIG.

14. In this manner, wiring to be performed when the wiring base 30 is docked with the body housing is extremely easy. After that, the top cover 4 is mounted from above and screwed. When the top cover 4 is mounted, the arm portion 39b of the switch operation member 39 is automatically inserted between the switching portion 38 of the switch 34 and the plate spring 41 from above.

As described above, the electric trimmer according to the embodiment has a configuration in which the pressing screws 11 are also screwed into the head cover 3 from below in the same manner as the motor fixing screws 12. Accordingly, both the female thread portions 74 for the motor fixing screws 12 and the female thread portions 70 for the pressing screws 11 are collected under the head cover 3. That is, the female thread portions 70 for the pressing screws 11 are absent above the head cover 3. Therefore, the thickness of the head cover 3 above the brush holders 9 can be reduced. The wiring base 30 is disposed in a space formed by the thickness reduction of the head cover 3. Thus, the overall height of the electric trimmer can be suppressed. That is, the female thread portions 70 for the pressing screws 11 do not have to be formed above the brush holders 9, but the thickness of the head cover 3 above the brush holders 9 can be reduced so that a space for installing the switch 34, the circuit board 36, the speed dial 37, etc. can be secured around the edge cover portion 14. As a result, the overall height of the electric trimmer can be suppressed.

In addition, the top surface 17 of the head cover 3 above the brush holders 9 is located in a lower position than the top surface of the edge cover portion 14 of the head cover 3, and the circuit board 36 is located between the height of the top surface of the edge cover portion 14 and the height of the top surface 17 of the head cover 3 above the brush holders 9. Thus, the overall height of the electric trimmer can be suppressed easily even when the circuit board 36 is provided.

Further, the top surface 17 of the head cover 3 above the brush holders 9 is formed as a flat surface, and the thickness of the flat-surface portion is reduced as shown in FIG. 5 and FIG. 13. It is therefore possible to mount the circuit board 36 in a lower position, so that it is possible to suppress the overall height of the electric trimmer. In addition, the bottom portion of the wiring base 30 is located between the circuit board 36 and the top surface 17 of the head cover 3 above the brush holders 9. A concave portion is formed in the lower surface of the bottom portion of the wiring base 30, and the top surface 17 of the head cover 3 above the brush holders 9 enters the concave portion. It is therefore possible to dispose the circuit board 36 in a further lower position.

Furthermore, the screwing positions of the motor fixing screws 12 are disposed to be shifted at predetermined angles in phase around the axis of the motor 1 with respect to the pressing screws 11. It is therefore possible to easily prevent interference between the female thread portions 74 for the motor fixing screws 12 and the female thread portions 70 for the pressing screws 11.

In addition, the avoidance hole 32 for avoiding interference with the edge cover portion 14 is formed in the wiring base 30. The edge cover portion 14 is upwardly inserted into the avoidance hole 32, and the circuit board 36 is disposed around the avoidance hole 32. It is therefore possible to easily place the circuit board 36 in a lower position than the top surface of the edge cover portion 14, so that it is possible to further suppress the overall height of the electric trimmer. At the same time, the area of the circuit board 36 can be secured easily when the circuit board 36 is disposed around the avoidance hole 32.

Electric components such as the switch 34, the power cord 35, the circuit board 36, the speed dial 37 and the like are attached to the wiring base 30 so that wiring with the top cover 4 can be eliminated. It is sufficient that the wiring base 30 is mounted on the upper portion of the head cover 3 and the top cover 4 is mounted thereon. Thus, the assembling performance is excellent. In addition, the two wiring cords 60, 61 from the motor 1 can be extracted upward by use of the avoidance hole 32 so that the wiring cords 60, 61 can be easily wired between the wiring base 30 and the body housing. Since the circuit board 36 is disposed above the wiring base 30, the wiring cords 60, 61 can be connected to the connectors 62, 63 or soldered therewith from above. Thus, electric wiring can be performed easily. In addition, when the switch operation member 39 is disposed in the top cover 4 and the top cover 4 is attached to the body housing, the switch operation member 39 can be automatically docked with the switch 34. Thus, the wiring work and the assembling work can be simplified, and the assembling time can be shortened.

In the embodiment, the motor fixing screws 12 and he pressing screws 11 are disposed to be shifted in phase. However, the motor fixing screws 12 and he pressing screws 11 may be disposed not to be shifted in phase but in the same phase. When the motor fixing screws 12 and the pressing screws 11 are set in the same phase, the pressing screws 11 can be disposed outward as long as they do not interfere with the motor fixing screws 12. In addition, the pressing screws 11 may be formed to have female thread portions at their centers like rasp-cut nuts, so that the motor fixing screws 12 can be screwed into the female threaded portions formed in the pressing screws 11.

In addition, the avoidance hole 32 is formed as a through hole in the aforementioned embodiment. However, the avoidance hole 32 may be formed like a notch or may be a non-through hole, that is, a concave portion formed in the lower surface of the bottom portion. In addition, the shape of the circuit board 36 is not limited to a Y shape, but various changes can be made on the shape.

### DESCRIPTION OF REFERENCE SIGNS

1 motor, 1a stator, 1b rotor, 2 motor case (housing), 3 head cover (housing), 4 top cover, 5 base, 6 motor shaft, 7 bearing, 8 chuck, 9 brush holder, 9a flat portion, 9b flat portion, 10 brush, 11 pressing screw, 12 motor fixing screw, 13 bearing, 14 edge cover portion, 14a flat surface portion, 15 screw, 16 boss portion, 17 top surface, 20 operation ring, 21 female thread portion, 22 female thread portion, 23 annular groove, 30 wiring base, 31 outer peripheral wall portion, 32 avoidance hole, 33 inner peripheral wall portion, 33a guide wall, 34 switch, 35 power cord, 36 circuit board, 37 speed dial, 38 switching portion, 39 switch operation member, 39a operation portion, 39b arm portion, 40 concave portion, 41 plate spring, 42 bent portion, 43 spring mounting wall, 50 plate-like portion, 51 cylindrical portion, 52 slit, 53 lever, 54 hook, 54a hook portion, 55 spring, 60 wiring cord, 61 wiring cord, 62 connector, 63 connector, 70 female thread portion, 71 light, 72 wiring cord, 73 cord guide, 74 female thread portion, 75 field coil

1. A vertical power tool comprising a housing that accommodates a motor having a vertically extending axis,
wherein a stator of the motor is screwed to an upper portion of the housing from below, a brush holder being laterally inserted into the upper portion of the housing, and a pressing screw is screwed into the housing from below to press an outer peripheral surface of the brush holder by a distal end portion of the pressing screw so that the brush holder is fixed to the housing in a pressed manner.

2. The vertical power tool according to claim 1, wherein a top surface of the housing above the brush holder is at a lower position than a top surface of an edge cover portion of the housing covering an upper end portion of a motor shaft, and a circuit board configured to control the motor is located between a height of the top surface of the edge cover portion and a height of the top surface of the housing above the brush holder.

3. The vertical power tool according to claim 1, wherein a position at which the stator of the motor is screwed is shifted by a predetermined angle around the axis of the motor with respect to the pressing screw.

4. The vertical power tool according to claim 2, wherein a position at which the stator of the motor is screwed is shifted by a predetermined angle around the axis of the motor with respect to the pressing screw.
